(19) United States
(12) Patent Application Publication
(10) Pub. No.: US 2007/0246654 A1
(43) Pub. Date: Oct. 25, 2007

(54) Banknote detection apparatus and banknote recognition system

(76) Inventors: Tien-Yuan Chien, Taipei (TW); Yueh-Ping Hsu, Taipei (TW); Chi-Tsung Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/494,515

(22) Filed: Jul. 28, 2006

(30) Foreign Application Priority Data
Apr. 19, 2006 (TW) 095206639

(51) Int. Cl. G01J 5/02

(52) U.S. Cl. 250/341.8

(57) ABSTRACT

A banknote detection apparatus and a banknote recognition system are disclosed. The apparatus is used for detecting special printing ink on a banknote and comprises a carrier set, at least a light emitter, at least a first light beam receiver and at least a second light beam receiver. The banknote is carried by the carrier set. The light emitter which is set at a side of the carrier set emits at least a detection light beam to illuminate the banknote. The first light beam receiver which is disposed at the same side receives a first image reflected by the special printing ink on the banknote, and the second light beam receiver which is disposed at another side receives a second image penetrated the special printing ink on the banknote. Lastly, a processing unit recognizes true or false of the banknote based on the first image and the second image.

### FIELD OF THE INVENTION

The present invention relates to a banknote detection and a banknote recognition system, and more particularly to receive images reflected and penetrated the special printing ink on a banknote to recognize true or false of the banknote.

### BACKGROUND OF THE INVENTION

As the technology is familiar with people, criminals may use technology to be guilty tool especially for counterfeit banknotes. Comparing with real banknotes, the appearance of counterfeit banknotes is not easy to be recognized due to increasingly developed technology. Moreover, to reduce human resources, machines are developed to perform business activities such as automatic vending machines, coin machines, automatic teller machines, etc. Counterfeit banknotes may cause the losses for business persons when they use these machines. Therefore, relative recognition techniques are developed to recognize counterfeit banknotes to ensure the benefits of the business persons. For instance, at least two different wavelengths are utilized to illuminate a banknote in order to sense waveform changes for a high waveform and a low waveform and different amplitude changes generated from the high waveform and the low waveform. The aforementioned changes are then compared with real banknote data to achieve the efficiency of accurately recognizing true or false of the banknote.

Although the conventional technique can achieve the aforementioned efficiency, the inventor does not satisfy. The inventor of the present invention based on years of experience on related research and development of the banknote recognition technique invents a banknote detection apparatus and a banknote recognition system.

### SUMMARY OF THE INVENTION

Accordingly, the object of the present invention is to provide a banknote detection apparatus and a banknote recognition system that receive images of reflection and transmission to recognize true or false of banknotes.

To achieve the aforesaid object, the banknote detection apparatus includes a carrier set, at least one light emitter, at least one first light beam receiver and at least one second light beam receiver. A banknote is carried on the carrier set. The light emitter disposed at a side of the carrier set emits at least one detection light beam to illuminate the banknote, and the first light beam receiver disposed at the same side of the carrier set receives a first image reflected by the special printing ink on the banknote. Alternatively the second light beam receiver disposed at another side of the carrier set receives a second image penetrated the special printing ink on the banknote. Lastly, a processing unit recognizes true or false for the first image or the second image through calculation.

Secondly, to achieve the aforesaid object, the banknote recognition system is applied to a banknote receiving apparatus to recognize true or false of the special printing ink on the banknote, and has a banknote receiving main body to provide basic function of receiving banknotes. Meanwhile, the banknote recognition system is disposed in the banknote receiving apparatus. The system includes at least one light driving module, a banknote detection apparatus, at least one light correction module, at least one light correction control module, at least one light voltage conversion module, at least one voltage digital conversion control module and a processing unit. The light driving module provides drive voltage to allow the banknote detection apparatus to obtain a first image or a second image. The light correction module corrects colors of the first image or colors of the second image based on a correction parameter. The light voltage conversion module converts the corrected first image or the corrected second image into voltage mode. The voltage digital conversion control module converts voltage mode into digital mode. The processing unit receives the digital mode of the first image or the second image to recognize true or false of the special printing ink on the banknote through calculation.

Therefore, in accordance with the present invention of the banknote detection apparatus and the banknote recognition system could recognize true or false of the banknote via images reflected and penetrated from the special printing ink.

Other features and advantages of the present invention and variations thereof will become apparent from the following description, drawings, and claims.

### BRIEF DESCRIPTION OF THE DRAWINGS

FIG. 1 is a block diagram illustrating a banknote detection apparatus according to an embodiment of the present invention;

FIG. 2 is a block diagram illustrating a banknote detection apparatus according to a preferred embodiment of the present invention;

FIG. 3 is a cross-sectional drawing illustrating a banknote detection apparatus according to a preferred embodiment of the present invention;

FIG. 4 is a cross-sectional drawing illustrating a banknote receiving apparatus according to a preferred embodiment of the present invention;

FIG. 5 is a perspective drawing illustrating an infrared light emitting diode (LED) and an infrared ray sensor integrated together according to FIG. 3;

FIG. 6 is a block diagram illustrating a banknote recognition system according to an embodiment of the present invention;

FIG. 7 is a circuit diagram illustrating a light emitter of a preferred embodiment accord to FIG. 6;

FIG. 8 is a circuit diagram illustrating a light beam receiver of a preferred embodiment according to FIG. 6;

FIG. 9 is a flowchart illustrating light correction according to a preferred embodiment of the present invention;

FIG. 10 is a block diagram illustrating another banknote detection apparatus according to an embodiment of the present invention;

FIG. 11 is a block diagram illustrating another banknote detection apparatus according to a preferred embodiment of the present invention;

FIG. 12 is a block diagram illustrating a further banknote detection apparatus according to an embodiment of the present invention; and

FIG. 13 is a block diagram illustrating a further banknote detection apparatus according to a preferred embodiment of the present invention.

### DETAILED DESCRIPTION OF THE PREFERRED EMBODIMENTS

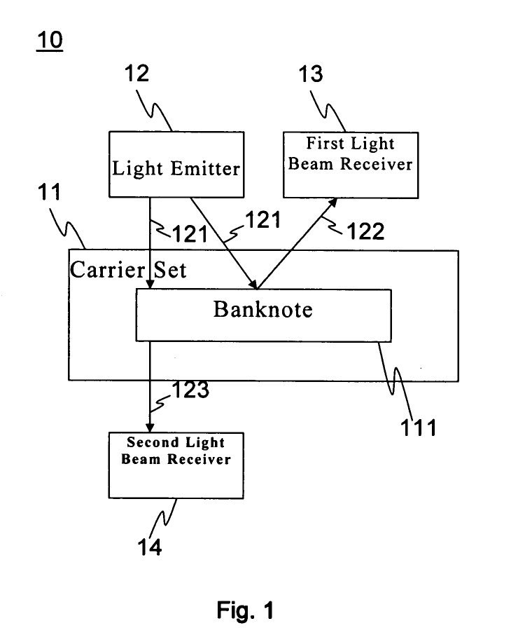

Referring to FIG. 1, a block diagram illustrates a banknote detection apparatus according to an embodiment of the present invention. The banknote detection apparatus 10 is applied in detecting special printing ink of a banknote. The apparatus includes a carrier set 11, at least one light emitter 12, at least one first light beam receiver 13 and at least one second light beam receiver 14. The carrier set 11 is for carrying a banknote 111. The light emitter 12 is disposed at a side of the carrier set 11 for emitting at least one detection light beam 121 to illuminate the banknote 111. The first light beam receiver 13 and the light emitter 12 are disposed at the same side of the carrier set 11 for receiving a reflection signal of the detection light beam reflected by the special printing ink on the banknote 111. The second light beam receiver 14 is disposed at another side of the carrier set 11 with the light emitter 12 for receiving a transmittance signal 123 of the detection light beam penetrated the special printing ink on the banknote 111.

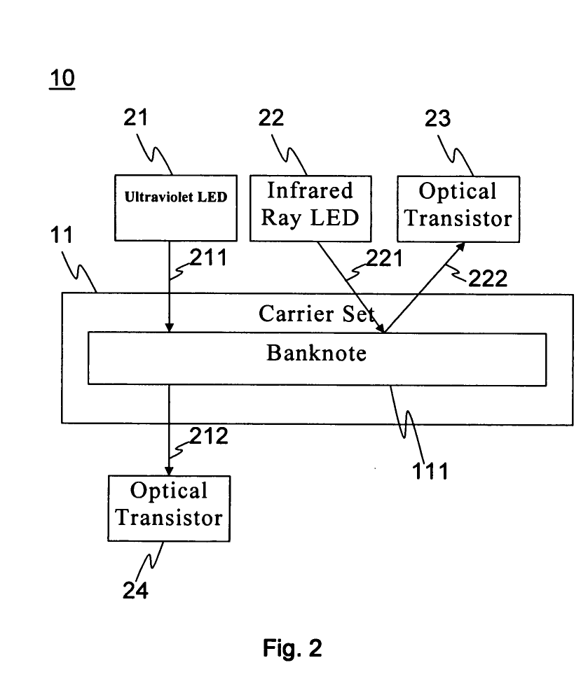

Referring to FIG. 2, a block diagram illustrates a banknote detection apparatus according to a preferred embodiment of the present invention. The banknote detection apparatus 10 includes the carrier set 11, an ultraviolet light emitting diode (LED) 21, an infrared ray light emitting diode (LED) 22 and optical transistors 23 and 24. The carrier set 11 is for carrying the banknote 111. The infrared ray LED 22 and the optical transistor 23 are disposed at the same side of the carrier set 11. The infrared ray LED 22 is for emitting an infrared ray detection light beam 221 to illuminate the banknote 111. The optical transistor 23 receives a first image 222 of the infrared ray detection light beam reflected by the special printing ink of the banknote 111. The ultraviolet LED 21 and the optical transistor 24 are disposed at a different side of the carrier set 11. The ultraviolet LED 21 is for emitting an ultraviolet detection light beam 211 to illuminate the banknote 111. The optical transistor 24 receives a second image 212 of the ultraviolet detection light beam penetrated the special printing ink on the banknote 111.

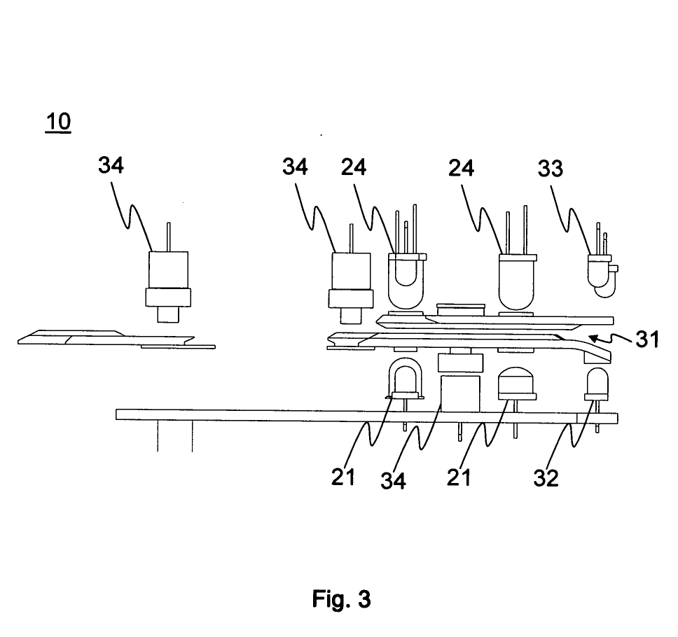

Referring to FIG. 3, a cross-sectional drawing illustrates a banknote detection apparatus according to a preferred embodiment of the present invention. As shown in FIG. 3, a channel 31 is formed to allow a banknote to be passed. When the banknote is transported to the channel 31, a LED 32 and an optical sensor 33 generate a control signal to activate the banknote detection apparatus. After the banknote is transported to the channel 31, the ultraviolet LED 21 and the optical transistor 24 which are disposed at two sides of the carrier set respectively detects a second image penetrated the special printing ink on the banknote. An infrared ray LED and an optical transistor 34, which are integrated together, detect a first image reflected by the special printing ink on the banknote.

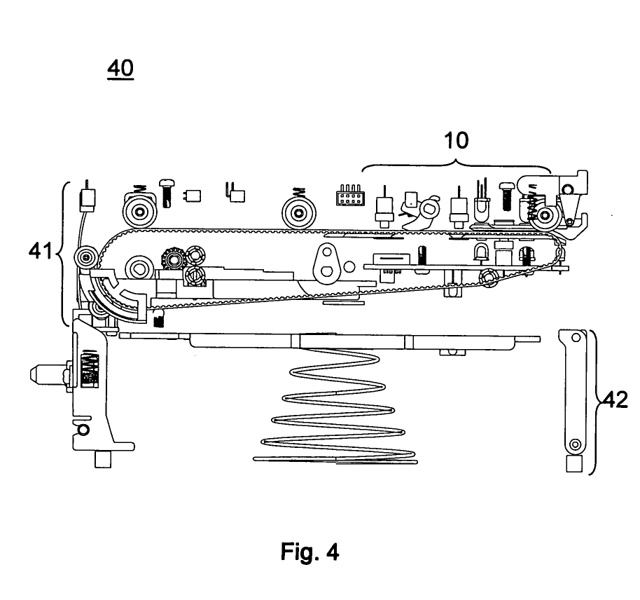

Referring to FIG. 4, a cross-sectional drawing illustrates a banknote receiving apparatus according to a preferred embodiment of the present invention. The banknote receiving apparatus 40 includes a shell (not shown), a banknote detection apparatus 10, a banknote transportation portion 41 and a banknote storage portion 42. A banknote is transported by the banknote transportation portion 41 to the banknote detection apparatus 10 for recognizing true or false. The banknote transportation portion 41 then transports the banknote o the banknote storage portion 42 for storing.

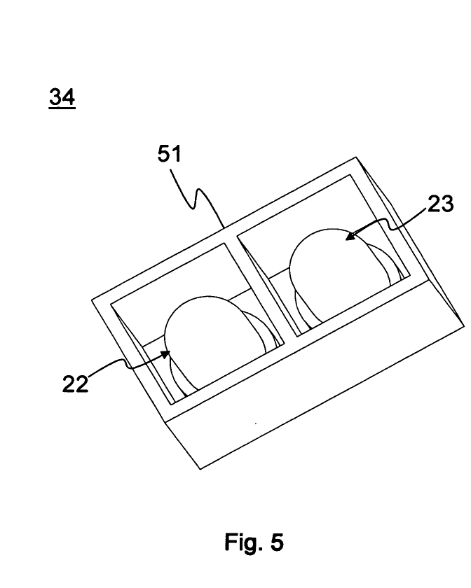

Referring to FIG. 5, a perspective drawing illustrates an infrared ray LED and an optical transistor integrated together according to FIG. 3. The infrared ray LED 22 and the optical transistor 23 are disposed in each partition of a base 51 respectively to form the infrared ray LED and the optical transistor 34 for emitting an infrared ray detection light beam and receiving a reflection signal.

In FIG. 1, 2, 3, 4 and 5, the light emitter 12 is preferably the ultraviolet LED 21 or the infrared ray LED 22 or both. The first light beam receiver 13 is preferably the infrared ray sensor. The infrared ray sensor is preferably the optical transistor 23. Alternatively the optical transistor 24 can directly replace the infrared ray sensor. The second light beam receiver 14 is preferably an optical sensor. The optical sensor is preferably the optical transistor 24. Alternatively the infrared ray sensor can directly replace. The detection light beam 121 emitted from the ultraviolet LED 21 is the ultraviolet detection light beam 211. The detection light beam 121 emitted from the infrared ray LED 22 is the infrared ray detection light beam 221. The reflection signal 122 is preferably formed the first image 222 or a reflection light or reflection colors. The transmittance signal 123 is preferably formed the second image 212 or a transmittance light or transmitted colors. The banknote detection apparatus 10 is further connected to a light correction module for correcting colors, images or lights of the reflection signal 122 and the transmittance signal 123. The light correction module is controlled by a correction parameter provided from a light correction control module. The banknote detection apparatus 10 is further connected to a light driving module to drive the light emitter 12 to emit the detection light beam 121.

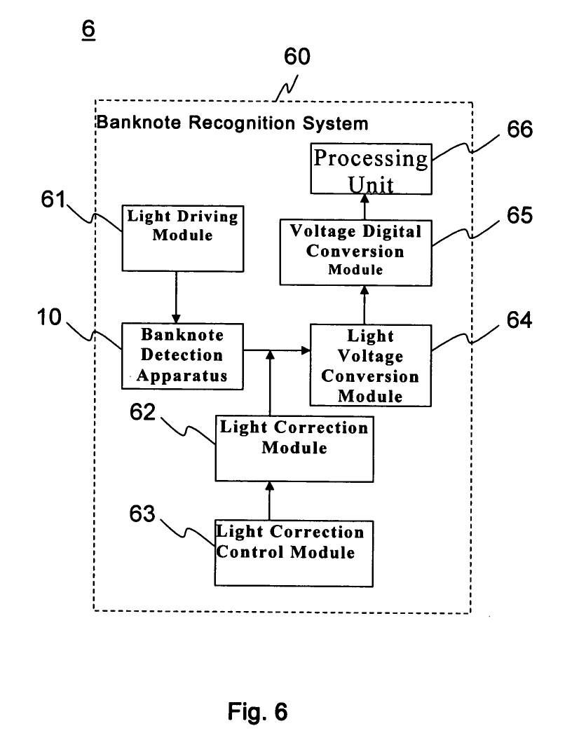

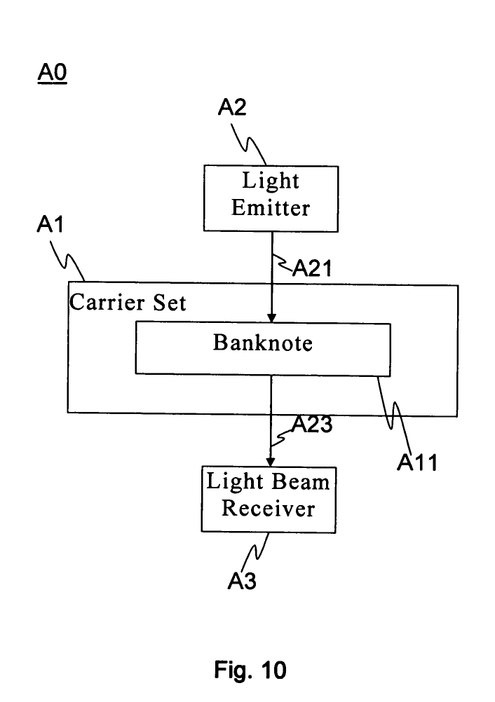

Referring to FIG. 6, a block diagram illustrates a banknote recognition system according to an embodiment of the present invention. The banknote recognition system 60 is applied to a banknote receiving apparatus 6 for recognizing true or false for the special printing ink on a banknote. The banknote receiving apparatus 6 has a banknote receiving main body for receiving the banknote. Meanwhile, the banknote recognition system 60 is disposed in the banknote receiving apparatus 6. The system includes at least one light driving module 61, a banknote detection apparatus 10, at least one light correction module 62, at least one light correction control module 63, at least one light voltage conversion module 64, at least one voltage digital conversion module 65 and a processing unit 66. The light driving module 61 provides drive voltage. The banknote detection apparatus 10 then detects the banknote to obtain a reflection signal and a transmittance signal. The light correction module 62 is controlled by at least one correction parameter provided from the light correction control module 63 to correct colors of the reflection signal and the transmittance signal. The light voltage conversion module 64 converts the reflection signal and the transmittance signal, which are corrected, into a voltage mode. The voltage digital conversion control module 65 converts the voltage mode into a digital mode. The processing unit 66 receives the digital mode of the reflection signal and the transmittance signal, which are converted, to recognize true or false of the special printing ink on the banknote through calculation. In addition, the banknote detection apparatus 10 as shown in FIG. 10 includes a carrier set 11, at least one light emitter 12, at least one first light beam receiver 13 and at least one second light beam receiver 14. The reflection signal 122 and the transmittance signal 123 are detected through the detection light beam 121.

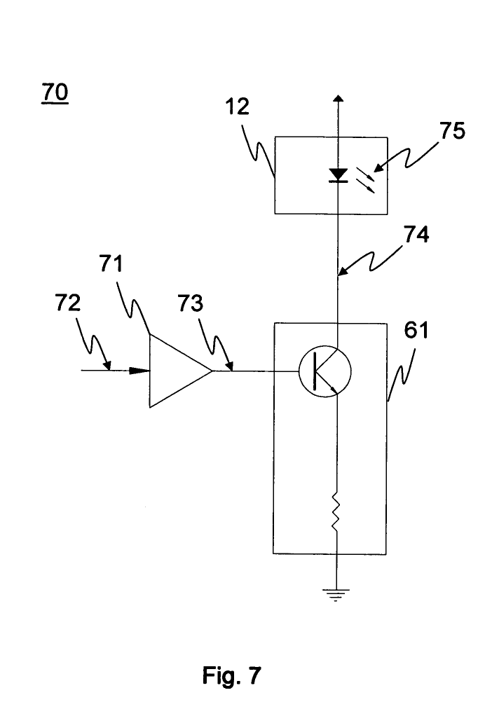

Referring to FIG. 7, a circuit diagram illustrates a light emitter of a preferred embodiment according to FIG. 6. A circuit 70 includes a light driving module 61, at least one light emitter 12 and a voltage control module 71. The voltage control module 71 receives a control signal 72 to output a voltage signal 73 to the light driving module 61. After the light driving module 61 receives the voltage signal 73, a drive voltage 74 is outputted to activate the light emitter 12 to emit a detection light beam 75.

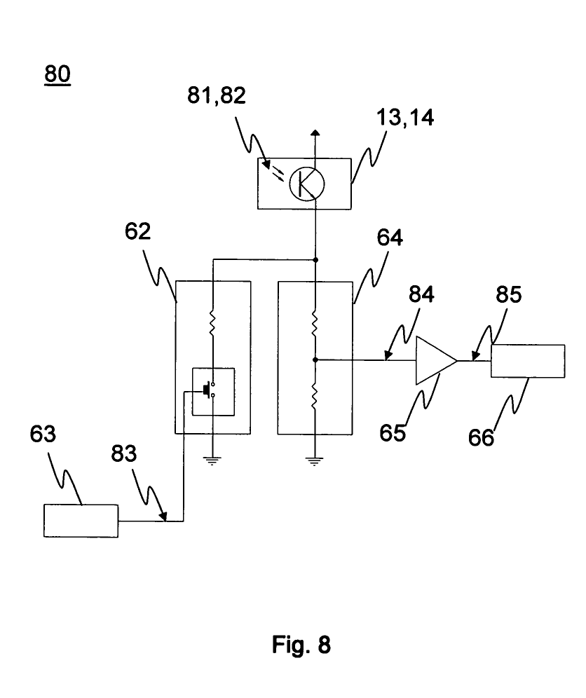

Referring to FIG. 8, a circuit diagram illustrates a light beam receiver of a preferred embodiment according to FIG. 6. A circuit 80 includes at least one light beam receiver 13 and 14, at least one light correction module 62, at least one light correction control module 63, at least one light voltage conversion module 64, at least one voltage digital conversion module 65 and a processing unit 66. After the light beam receiver 13 and 14 receive a reflection signal 81 or a transmittance signal 82, the light correction control module 63 provides at least one correction parameter 83 to the light correction module 62 for correcting colors of the reflection signal 81 or the transmittance signal 82. The light voltage conversion module 64 then converts the reflection signal 81 or the transmittance signal 82 into a voltage mode 84. The voltage digital conversion control module 65 converts the voltage mode 84 into a digital mode 85. The processing unit 66 receives the digital mode 85 of the reflection signal 81 or the transmittance signal 82 to recognize true or false of the special printing ink on the banknote.

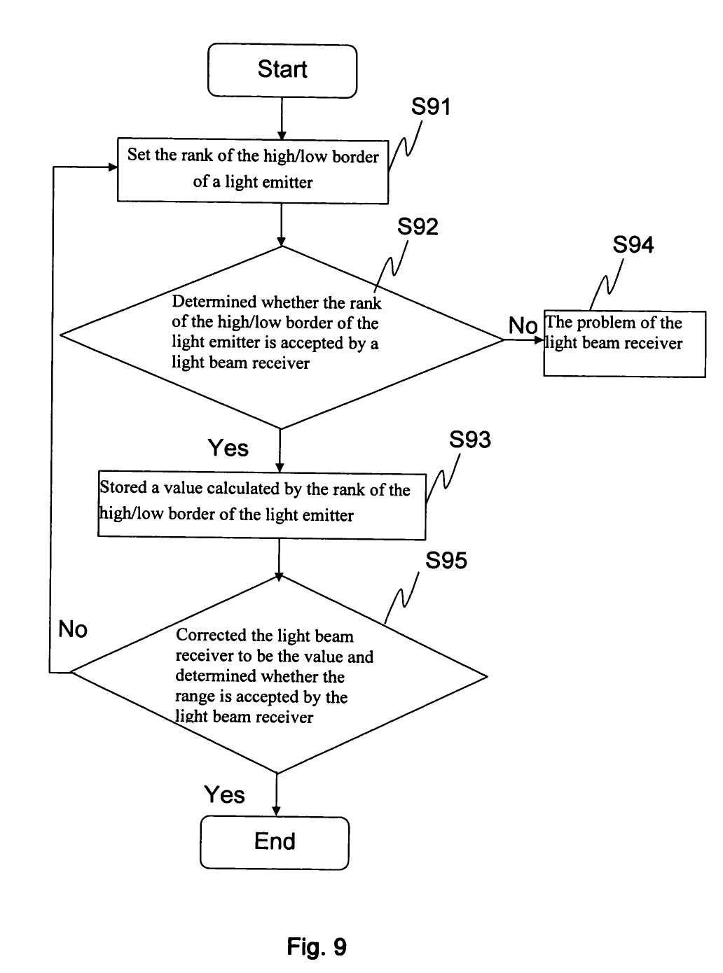

Referring to FIG. 9, a flowchart illustrates a light correction according to preferred embodiment of the present invention. The flowcharts includes following steps:

Step S91: Set the rank of the high/low border of a light emitter.

Step S92: Determined whether the rank of the high/low border of the light emitter is accepted by a light beam receiver. If the rank of the high/low border of the light emitter is accepted by a light beam receiver, step S93 is performed. Otherwise, step S94 is performed.

Step S93: Stored a value calculated by the rank of the high/low border of the light emitter.

Step S94: The problem of the light beam receiver.

Step S95: Corrected the light beam receiver to be the value and determined whether the range is accepted by the light beam receiver. If the range is accepted by the light beam receiver, the light correction procedure is finished. Otherwise, step S91 is performed.

In FIG. 6, 7, 8 and 9, the light emitter 12 is preferably the ultraviolet LED 21 or the infrared ray LED 22 or both. The first light beam receiver 13 is preferably the infrared ray sensor. The infrared ray sensor is preferably the optical transistor 23. Alternatively the optical transistor 24 can directly replace. The second light beam receiver 14 is preferably the optical sensor. The optical sensor is preferably the optical transistor 24. Alternatively the infrared ray sensor can directly replace. The detection light beam 121 emitted from the ultraviolet LED 21 is the ultraviolet detection light beam 75. The detection light beam 121 emitted from the infrared ray LED 22 is the infrared ray detection light beam 75. The reflection signal 81 is preferably formed an image signal or the reflection light or reflection colors. The transmittance signal 82 is preferably formed an image signal or a transmittance light or transmitted colors. The processing unit 66 is preferably a microprocessor. Moreover, the banknote recognition system 60 further includes a banknote feature database which is disposed in the banknote receiving apparatus 6. The banknote feature database provides features of the special printing ink on the banknote to the processing unit 66 for recognizing true or false. The processing unit 66 recognizes true or false for colors, images, or lights of the reflection signal 81 and the transmittance signal 82 through calculation.

Referring to FIG. 10, a block diagram illustrates a banknote detection apparatus according to an embodiment of the present invention. The banknote detection apparatus A0 is applied in detecting the special printing ink on a banknote. The apparatus includes a carrier set A1, at least one light emitter A2 and at least one light beam receiver A3. The carrier set A1 is for carrying a banknote A11. The light emitter A2 is disposed a side of the carrier set A1 for emitting at least one detection light beam A21 to illuminate the banknote A11. The light beam receiver A3 is disposed at another side of the carrier set A1 with the light emitter A3 for receiving a transmittance signal A23 of the detection light beam penetrated the special printing ink on the banknote A11.

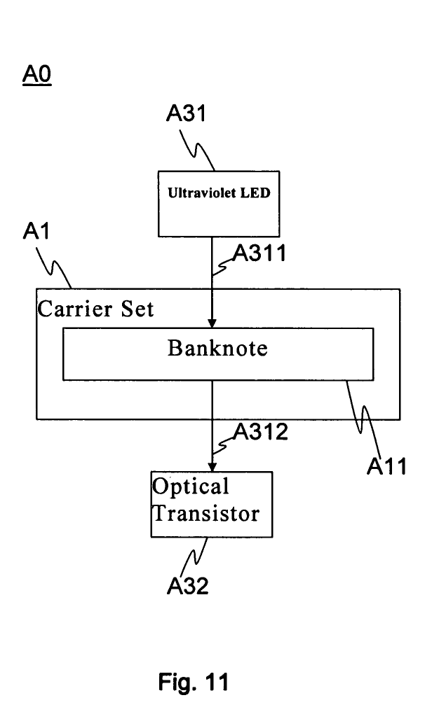

Referring to FIG. 11, a block diagram illustrates a banknote detection apparatus according to a preferred embodiment of the present invention. The banknote detection apparatus A0 includes a carrier set A1, an ultraviolet LED A31 and an optical transistor A32. The carrier A1 is for carrying the banknote A11. The ultraviolet LED A31 is disposed at a different side of the carrier set A1 with the optical transistor A32 for emitting an ultraviolet detection light beam A311 to illuminate the banknote A11. The optical transistor A32 receives an image A312 of the ultraviolet detection light beam penetrated the special prinking ink on the banknote A11.

In FIG. 10 and 11, the light emitter A2 is preferably the ultraviolet LED A31 or the infrared ray LED or both. The light beam receiver A3 is preferably the optical sensor. The optical sensor is preferably the optical transistor A32. The detection light beam A21 emitted from the ultraviolet LED A31 is the ultraviolet detection light beam A311. The detection light beam A21 emitted from the infrared ray LED is the infrared ray detection light beam. The transmittance signal A23 is preferably formed the image A312 or transmitted lights or transmitted colors. Moreover, the banknote detection apparatus A0 is further connected to a light correction module for correcting colors, images or lights of the transmittance signal A23. The light correction module is controlled by at least one correction parameter provided by a light correction control module. The banknote detection apparatus A0 is further connected to a light driving module to drive the light emitter A2 to emit the detection light beam A21.

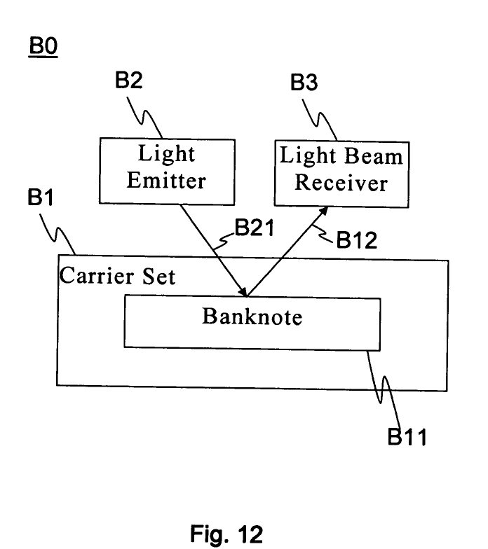

Referring to FIG. 12, a block diagram illustrates a banknote detection apparatus according to an embodiment of the present invention. The banknote detection apparatus B0 is applied in detecting the special printing ink on the banknote. The apparatus includes a carrier set B1, at least one light emitter B2 and at least one light beam receiver B3. The carrier set B1 is for carrying a banknote B11. The light emitter B2 is disposed at a side of the carrier set B1 for emitting at least one detection light beam B21 to illuminate the banknote B11. The light beam receiver B3 and the light emitter B2 are disposed at the same side of the carrier set B1 for receiving a reflection signal B22 of the detection light beam reflected from the special printing ink on the banknote B11.

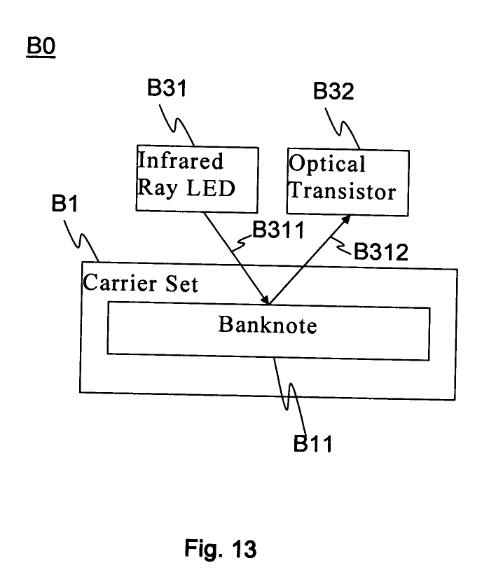

Referring to FIG. 13, a block diagram illustrates a banknote detection apparatus according to a preferred embodiment of the present invention. The banknote detection apparatus B0 includes a carrier set B1, an infrared ray LED B31 and an optical transistor B32. The carrier set B1 is for carrying the banknote B11. The infrared ray LED B31 and the optical transistor B32 are disposed at the same side of the carrier set B1. The infrared ray LED B31 is for emitting an infrared ray detection light beam B311 to illuminate the banknote. The optical transistor B32 receives an image B312 of the infrared ray detection light beam reflected from the special printing ink on the banknote B11.

In FIG. 12 and 13, the light emitter B2 is preferably the infrared ray LED B31 or the ultraviolet LED. The optical sensor is preferably the optical transistor A32. The detection light beam B11 emitted from the infrared ray LED B31 is the infrared ray detection light beam B311. The detection light beam B11 emitted from the ultraviolet LED is the ultraviolet detection light beam. The reflection signal B22 is preferably formed the image B312 or reflection lights or reflection colors. The banknote detection apparatus B0 is further connected to a light correction module for correcting colors, images or lights of the reflection signal B22. The light correction module is controlled by at least one correction parameter provided by a light correction control module. The banknote detection apparatus B0 is further connected to a light driving module to drive the light emitter B2 to emit the detection light beam B11.

Although the features and advantages of the embodiments according to the preferred invention are disclosed, it is not limited to the embodiments described above, but encompasses any and all modifications and changes within the spirit and scope of the following claims.

What is claimed is:

1. A banknote detection apparatus for use in detecting the special printing ink on a banknote, comprising:
a carrier set carried said banknote;
at least one light emitter disposed at a side of said carrier set for emitting at least one detection light beam to illuminate said banknote;
at least a first light beam receiver disposed at the same side of said carrier set with said light emitter for receiving a reflection signal of said detection light beam reflected by the special printing ink on said banknote; and
at least one second light beam receiver disposed at another side of said carrier set with said light emitter for receiving a transmittance signal of said detection light beam penetrated the special printing ink on said banknote.

2. The banknote detection apparatus of claim 1, wherein said light emitters are an ultraviolet light emitting diode or an infrared ray light emitting diode.

3. The banknote detection apparatus of claim 1, wherein said first light receiver is an infrared ray sensor.

4. The banknote detection apparatus of claim 3, wherein said infrared ray sensor is an optical transistor.

5. The banknote detection apparatus of claim 1, wherein said second light beam receivers are an optical sensor.

6. The banknote detection apparatus of claim 5, wherein said optical sensor is an optical transistor.

7. The banknote detection apparatus of claim 1, wherein said detection light beam is an infrared rays or an ultraviolet.

8. The banknote detection apparatus of claim 1, wherein said reflection signal is formed a first image.

9. The banknote detection apparatus of claim 1, wherein said transmittance signal is formed a second image.

10. The banknote detection apparatus of claim 1, wherein said banknote detection apparatus is further connected to a light correction module for correcting colors of said reflection signal and colors of said transmittance signal.

11. The banknote detection apparatus of claim 10, wherein said light correction module is controlled by a light correction control module.

12. The banknote detection apparatus of claim 11, wherein said light correction control module further includes at least one correction parameter for controlling.

13. The banknote detection apparatus of claim 1, wherein said banknote detection apparatus is further connected to a light driving module for driving said detection light beams generated by said light emitters.

14. A banknote recognition system for use in a banknote receiving apparatus to recognize true or false of the special printing ink on a banknote, said banknote receiving apparatus having a banknote receiving main body to receive said banknote, said banknote recognition system comprising:
at least one light driving module disposed in said banknote receiving apparatus to provide a drive voltage;
a banknote detection apparatus disposed in said banknote receiving apparatus, said banknote detection apparatus having a carrier set, at least one light emitter, at least one first light beam receiver and at least one second light beam receiver, wherein said carrier set is for carrying said banknote, and said light emitters are disposed at a side of said carrier set for receiving said drive voltage to emit at least one detection light beam to illuminate said banknote, and said first light beam receivers are disposed at the same side of said carrier set with said light emitters for receiving a reflection signal of said detection light beam reflected by the special printing ink on said banknote, and said second light beam receivers are disposed at another side of said carrier set with said light emitters for receiving a transmittance signal of said detection light beam penetrated the special printing ink on said banknote;
a light bean correction module disposed in said banknote receiving apparatus to correct colors of said reflection signal and colors of said transmittance signal based on a correction parameter; and
a processing unit disposed in said banknote receiving apparatus to recognize true or false of the special printing ink on said banknote through calculation from corrected said reflection signal and corrected said transmittance signal.

15. The banknote recognition system of claim 14, wherein said light emitters are an ultraviolet light emitting diode or an infrared ray light emitting diode.

16. The banknote recognition system of claim 14, wherein said first light beam receivers are an infrared ray sensor.

17. The banknote recognition system of claim 16, wherein said infrared ray sensor is an optical transistor.

18. The banknote recognition system of claim 14, wherein said second light beam receivers are an optical sensor.

19. The banknote recognition system of claim 18, wherein said optical sensor is an optical transistor.

20. The banknote recognition system of claim 14, wherein said detection light beam is an infrared ray or an ultraviolet.

21. The banknote recognition system of claim 14, wherein said processing unit is a microprocessor.

22. The banknote recognition system of claim 14, wherein said banknote recognition system further includes a banknote feature database, and said banknote feature database is disposed in said banknote receiving apparatus for providing features of the special printing ink on said banknote to be recognized by said processing unit.

23. The banknote recognition system of claim 14, wherein said processing unit recognizes true or false for colors of said reflection signal and colors of said transmittance signal through calculation.

24. The banknote recognition system of claim 14, wherein said reflection signal is an image signal.

25. The banknote recognition system of claim 14, wherein said transmittance signal is an image signal.

26. The banknote recognition system of claim 14, wherein said banknote recognition system further includes a light voltage conversion module and a voltage digital conversion module.

27. A banknote detection apparatus for use in detecting the special printing ink of a banknote, comprising:
a carrier set carried said banknote;
at least one light emitter disposed at a side of said carrier set for emitting at least one detection light beam to illuminate said banknote; and
at least one light beam receiver disposed at another side of said carrier set with said light emitter for receiving a transmittance signal of said detection light beam penetrated the special printing ink on said banknote.

28. The banknote detection apparatus of claim 27, wherein said light emitters are an ultraviolet light emitting diode or an infrared ray light emitting diode.

29. The banknote detection apparatus of claim 27, wherein said light beam receiver is an optical sensor.

30. The banknote detection apparatus of claim 29, wherein said optical sensor is an optical transistor.

31. The banknote detection apparatus of claim 27, wherein said detection light beam is an infrared ray or an ultraviolet.

32. The banknote detection apparatus of claim 27, wherein said transmittance signal is formed an image.

33. The banknote detection apparatus of claim 27, wherein said banknote detection apparatus is further connected to a light correction module for correcting colors of said transmittance signal.

34. The banknote detection apparatus of claim 33, wherein said light correction module is controlled by a light correction control module.

35. The banknote detection apparatus of claim 34, wherein said light correction control module further includes at least one correction parameter for controlling.

36. The banknote detection apparatus of claim 27, wherein said banknote detection apparatus is further connected to a light driving module to drive said light emitters to generate said detection light beams.

37. A banknote detection apparatus for use in detecting the special printing ink on a banknote, comprising:
a carrier set carried said banknote;
at least one light emitter disposed at a side of said carrier set for emitting at least one detection light beam to illuminate said banknote; and
at least one light beam receiver disposed at the same side of said carrier set with said light emitter for receiving a reflection signal of said detection light beam reflected by the special printing ink on said banknote.

38. The banknote detection apparatus of claim 37, wherein said light emitters are an ultraviolet light emitting diode or an infrared ray light emitting diode.

39. The banknote detection apparatus of claim 37, wherein said light beam receiver is an optical sensor.

40. The banknote detection apparatus of claim 39, wherein said optical sensor is an optical transistor.

41. The banknote detection apparatus of claim 37, wherein said detection light beam is an infrared ray or an ultraviolet.

42. The banknote detection apparatus of claim 37, wherein said reflection signal is formed an image.

43. The banknote detection apparatus of claim 37, wherein said banknote detection apparatus is further connected to a light correction module for correcting colors of said reflection signal.

44. The banknote detection apparatus of claim 43, wherein said light correction module is controlled by a light correction control module.

45. The banknote detection apparatus of claim 44, wherein said light correction control module further includes a correction parameter for controlling.

46. The banknote detection apparatus of claim 37, wherein said banknote detection apparatus is further connected to a light driving module to drive said light emitters to generate said detection light beams.
